(19) United States
(12) Patent Application Publication
(10) Pub. No.: US 2023/0156875 A1
(43) Pub. Date: May 18, 2023

(54) Induction Coil Arrangement

(71) Applicant: Vestel Elektronik Sanayi ve Ticaret A.S., Manisa (TR)

(72) Inventor: Hamdullah Cihangir TOPAC, Manisa (TR)

(21) Appl. No.: 17/802,915

(22) PCT Filed: Feb. 27, 2020
(86) PCT No.: PCT/EP2020/055180

§ 371 Date: Aug. 26, 2022

(51) Int. Cl. H05B 6/12

(52) U.S. Cl. CPC H05B 6/1245; H05B 2206/022

(57) ABSTRACT

An induction coil arrangement is provided for use in inductive transfer of power to an object that is formed of or contains a ferromagnetic material. The induction coil arrangement has an induction coil and a support to which the induction coil is mounted to support the induction coil. The support is flexible so as to allow the induction coil to move. The support has a plurality of permanent magnets arranged such that, when an object that is formed of or contains a ferromagnetic material is placed over the support, the permanent magnets interact with the ferromagnetic material of the object to move the induction coil relative to a said object so as to centre the induction coil relative to the object.

### TECHNICAL FIELD

The present disclosure relates to an induction coil arrangement.

### BACKGROUND

In an induction cooker, a varying electric current is passed through an induction coil of the cooker. The coil therefore produces a corresponding varying electromagnetic field. The varying electromagnetic field induces a varying eddy current in a cooking vessel made or of containing a ferromagnetic material or the like when the cooking vessel is placed in close proximity to the induction coil. This eddy current in turn heats the cooking vessel and therefore the contents of the cooking vessel. It is beneficial for the cooking vessel to be positioned centrally over the induction coil to ensure an intended heating effect and to maximise the heating effect and efficiency.

Similarly, in inductive charging of a rechargeable battery or inductive powering of a device, a power-receiving coil associated with the battery or device is preferably located centrally over the power-transmitting coil of an inductive charger or power-delivery apparatus in order to maximise the efficiency of power transfer. Again, users may not always locate the power-receiving coil centrally over the power-transmitting coil.

### SUMMARY

According to an aspect disclosed herein, there is provided an induction coil arrangement for use in inductive transfer of power to an object that is formed of or contains a ferromagnetic material, the arrangement comprising:

an induction coil; and

a support to which the induction coil is mounted to support the induction coil, the support being flexible so as to allow the induction coil to move;

the support having a plurality of permanent magnets arranged such that, when a said object that is formed of or contains a ferromagnetic material is placed over the support, the permanent magnets interact with the ferromagnetic material of the object to move the induction coil relative to a said object so as to centre the induction coil relative to a said object.

The support can flex or deform which allows the induction coil to move. This enables the induction coil to be automatically centred relative to the object as a whole, such as in the case of an induction hob or other induction heater, and/or centred relative to an induction coil associated with the object, such as in the case of inductive charging or powering of the object. This ensures that power is transferred more efficiently. No power source or drive motor or the like is required to move the induction coil of the induction coil arrangement.

It will be understood that when it is mentioned herein that the induction coil is “centred” relative to a said object, the induction coil need not be precisely centred, and that is may be sufficient simply to move the induction coil to be nearer the centre of the object.

In an example, the permanent magnets are spaced around a periphery of the support.

In an example, the support is a closed bag which contains a fluid.

The fluid may be one or more liquids or one or more gases. Most conveniently, the fluid is air.

In an example, the support is a closed bag which has a generally oblate spheroidal or toroidal shape and which contains a fluid, the permanent magnets being in the form of strips which are arranged radially on the closed bag support.

A bag with a toroidal shape is in general less flexible than a bag with an oblate spheroidal shape. A toroidal shape may be preferred if less movement of the indiction coil relative to a said object is desired. An oblate spheroidal shape, which is like a “squashed” sphere, may be preferred if more movement of the induction coil relative to a said object is desired.

In an example, at least some of the permanent magnets extend to the periphery of the support.

In an example, the closed bag support comprises one or more reinforcing ribs.

The reinforcing ribs assist in controlling the flexing or deformation of the closed bag support.

In an example, the induction coil comprises a base for fixing the induction coil arrangement to an apparatus, the support being fixed to the base and arranged such that the induction coil can move relative to the base.

There may also be provided an induction cooker comprising an induction coil arrangement as described above.

There may also be provided an electrical power delivery apparatus for charging and/or powering an apparatus, the electrical power delivery apparatus comprising an induction coil arrangement as described above.

### BRIEF DESCRIPTION OF THE DRAWINGS

To assist understanding of the present disclosure and to show how embodiments may be put into effect, reference is made by way of example to the accompanying drawings in which:

FIG. 1 shows schematically a perspective of an example of an induction cooker;

FIG. 2 shows schematically a partly phantom perspective view of an example of an induction coil arrangement according to the present disclosure;

FIGS. 3A and 3B show schematically the example of the induction coil arrangement after the induction coil has moved; and

FIG. 4 shows schematically a sectioned side elevation of a part of the example of the induction coil arrangement.

### DETAILED DESCRIPTION

As mentioned previously, if a cooking or other vessel is not, or cannot, be positioned to be centrally above an induction coil of an induction cooker or other inductive heater, the vessel will not be heated in an intended way. In an induction cooker or other inductive heater, heating is most efficient or effective if the vessel is located centrally over the induction coil. In practice, however, users may not always accurately align the vessel with the induction coil or this may not be possible. Similarly, as mentioned, in inductive charging of a rechargeable battery or inductive powering of a device, etc., a power-receiving coil associated with the battery or device is preferably located centrally over the power-transmitting coil of the inductive charger or other power-delivery apparatus in order to maximise the efficiency of power transfer to the battery or device. Again, users may not always locate the power-receiving coil of the battery or device centrally over the power-transmitting coil.

Examples described herein provide an induction coil arrangement in which the induction coil automatically aligns with the object to which power is to be transferred. The power-transmitting coil is supported by a flexible support. The support has a number of permanent magnets. The permanent magnets and support are arranged such that, when the object, which is formed of or contains a ferromagnetic material, is placed over the support but is not correctly centred over the induction coil, the permanent magnets interact with the ferromagnetic material of the object to move the induction coil relative to the object, in particular so as to centre the induction coil relative to the object (or at least drive the induction coil towards being centred under the object even if it cannot be exactly centred under the object). This enables a more efficient transfer of electrical power to the object.

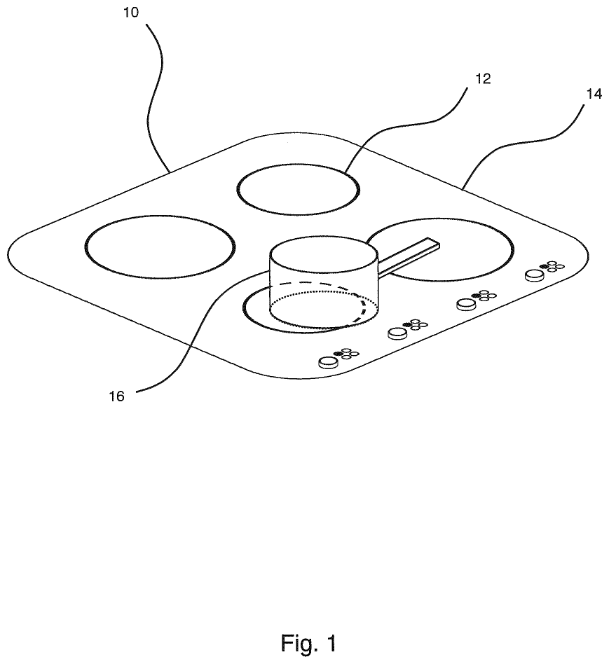

Referring now to FIG. 1, there is shown a schematic perspective view of an example of an induction cooker 10. The induction cooker 10 of this example is a hob having one or more heating areas or zones 12. In this example, the induction cooker 10 comprises four heating areas or zones 12, though there may be more or fewer heating areas or zones 12. The induction cooker 10 may optionally also comprise at least one of a grill and an oven (not shown). The induction cooker 10 has an upper surface 14, which typically is formed of glass, ceramic, etc. The or each heating area or zone 12 has an induction coil (not visible in FIG. 1) under the upper surface 14.

A cooking vessel 16 is shown in FIG. 1 placed on the upper surface 14 and generally over a heating area 12 of the cooker 10. The cooking vessel 16 has a ferromagnetic base. In an example, the cooking vessel 16 may be made entirely of a ferromagnetic material.

When the induction cooker 10 is in operation, the induction coil associated with the heating area 12 over which the cooking vessel 16 is placed is energised by an alternating current. This induces eddy currents in the ferromagnetic material of the cooking vessel 16, which causes an increase in the temperature of the cooking vessel 16 through resistive heating.

For even and efficient heating of the cooking vessel 16, the cooking vessel 16 is ideally placed directly and centrally above the induction coil of the heating area 12. However, as shown in FIG. 1, part of the base of the cooking vessel 16 is not in contact with or above the heating area 12, because for example the user has not correctly placed the cooking vessel 16 centrally over the heating area 12. This reduces the efficiency of power transfer to the cooking vessel 16 and therefore reduces the efficiency of heating of the cooking vessel 16.

Similar considerations apply in the case that the induction coil is part of an electrical charging or other power-delivery apparatus, which is used to charge a rechargeable battery of an object or otherwise deliver electrical power to an object to be powered, including for example an electric vehicle, a portable electric device such as a smart phone, portablecomputer, etc.

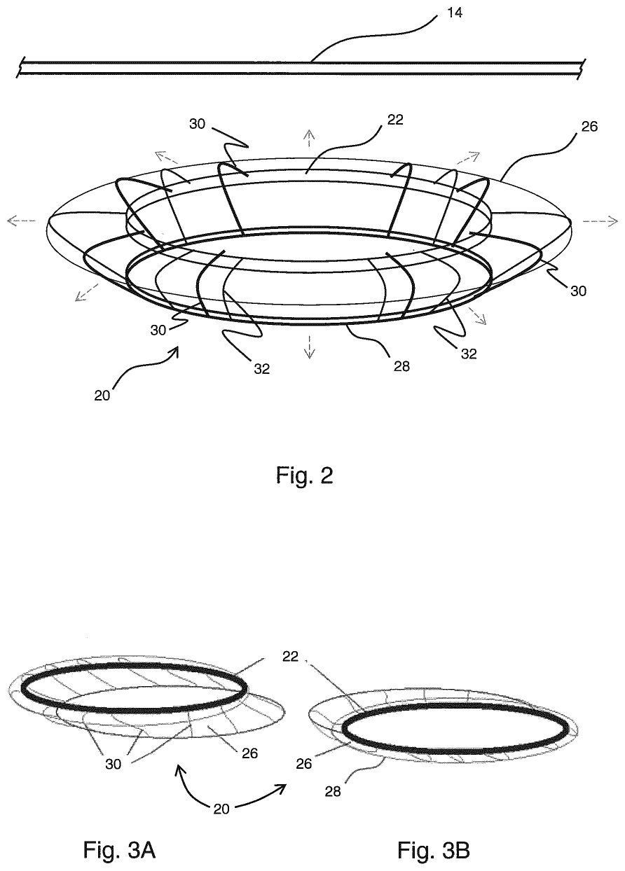

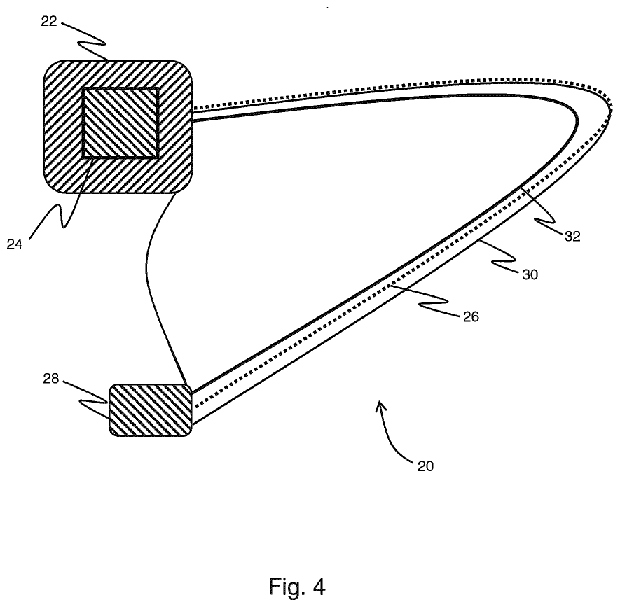

Referring now to FIGS. 2 to 4, there are shown schematic views of an example of an induction coil arrangement 20 according to the present disclosure. FIG. 2 shows the induction coil arrangement 20 as part of an induction cooker and therefore just below the upper surface 14 of the induction cooker as described above. In other examples, such as when used in some electrical charging or other power-delivery apparatus, such an upper surface 14 may not be necessary and/or may have a different form suitable for supporting the object which is to be charged or powered.

The induction coil arrangement 20 has an induction coil 22. As conventional, the induction coil 22 of this example is annular, that is, in the form of a ring or torus. The induction coil 22 has a ferrite core 24 in this example. The induction coil 22 is supported or carried by a support 26.

In this example, the induction coil arrangement 20 has a base 28. The base 28 can be used to mount the induction coil arrangement 20 in some other apparatus or device or substrate, such as an induction cooker 10 as described above or some inductive charging or powering device. The base 28 may for example have an external screw thread which enables the whole induction coil arrangement 20 to be fixed by screwing the base 28 into a corresponding screw threaded hole in the other apparatus or device or substrate. The base 28 may not always be necessary, and for example the support 26 may be fixed directly to the other apparatus or device or substrate.

The support 26 is flexible, which allows the induction coil 22 to move. This is shown schematically in FIGS. 3A and 3B which may be compared with FIG. 2. In particular, in FIG. 2, the induction coil 22 is arranged generally centrally of the induction coil arrangement 20. This may be the default, “rest” location of the induction coil 22. In FIG. 3A, the flexible support 26 has deformed or distorted to allow the induction coil 22 to move to the left relative to the body of the induction coil arrangement 20 as indicated by the arrow A. In FIG. 3B, the flexible support 26 has deformed or distorted to allow the induction coil 22 to move to dr right relative to the body of the induction coil arrangement 20 as indicated by the arrow B.

To drive the movement of the induction coil 22, the support 26 has plural permanent magnets 30. The permanent magnets 30 are arranged such that when an object that is formed of or contains a ferromagnetic material is placed over but not centrally of the induction coil 22/support 26, the permanent magnets 30 interact with the ferromagnetic material of the object to move the induction coil 22 relative to the object so as to centre the induction coil 22 relative to the object. In particular, the permanent magnets 30 interact with the ferromagnetic material of the object to “pull” the induction coil 22 towards the centre of the object. This shifts the induction coil 22 sideways (as shown by arrows in FIG. 2 and shown in FIGS. 3A and 3B). The sideways movement of the induction coil 22 continues until the induction coil 22 is centred under the object to be heated or charged or powered. As will become clear, in an example, this movement of the induction coil 22 will cease when the induction coil 22 is centred under the object because the forces on the induction coil 22 will be generally symmetrically balanced. It is noted that, in practice, there may be other constraints on movement of the induction coil 22, including for example physical constraints such as other parts of the cooker or charging or power-delivery apparatus or the surrounding apparatus or environment, such that the induction coil 22 may be moved towards being centred under the object, but the movement ceases before the induction coil 22 is exactly centred under the object. In any event, the movement of the induction coil 22 to centre it is achieved without requiring any sensors or the like to detect the position of the object to be heated or charged or powered or of the induction coil 22. Further, this is achieved without requiring any motor or the like to drive movement of the induction coil 22. Further, no control software or control circuitry or the like is required. The induction coil arrangement 20 can be entirely “passive” and not require any control circuitry or power supply.

In an example, the permanent magnets 30, or at least some of the permanent magnets 30, or at least a part of at least some of the permanent magnets 30, are arranged to be spaced around the periphery of the support 26. This helps to ensure that the ferromagnetic material of the object to be heated or charged or powered can interact with the permanent magnets 30 to pull the induction coil 22 to be centred even if the object is relatively far from being centred when initially located over the induction coil 22.

In an example, the permanent magnets 30 are distributed equiangularly around the periphery of the support 26. In other examples, there may be advantage in arranging the permanent magnets 30 not to be distributed equiangularly around the periphery of the support 26. For example, the permanent magnets 30 may be arranged to cause the induction coil 22 to be preferentially or more forcefully driven in one direction rather than another, for example by having a greater number of permanent magnets 30 and/or a number of more powerful permanent magnets 30 at a particular region than at others.

In an example, the permanent magnets 30 are in the form of strips, that is, the permanent magnets 30 are relatively narrow and elongate. In an example, the permanent magnets 30, or at least some of the permanent magnets 30, extend to the periphery of the support 26. The ends of (at least some of) the permanent magnets 30 may wrap around the periphery of the support 26 so as to envelop the periphery of the support 26. These options for arranging the permanent magnets 30 variously contribute to improving the strength of the interaction between the permanent magnets 30 and the ferromagnetic material of the object and therefore increase the force that is applied to distort the support 26 and therefore move the induction coil 22.

Especially when in the form of strips, the permanent magnets 30 may be fixed at one end to the base 28. In an example, the other ends the permanent magnets 30 may be fixed to the induction coil 22. The permanent magnets 30 may be fixed only at their ends (to the base 28 and the induction coil 22 respectively) or may also be fixed along their length to the support 26.

Referring now to the support 26 in a little more detail, as mentioned the support 26 is flexible, which allows the induction coil 22 to move when the permanent magnets 30 interact with the ferromagnetic material of the object to be heated or charged or powered. In an example, the support 26 is in the form of a closed bag. The bag-like support 26 contains a fluid, which may be one or more liquids or one or more gases to provide additional resilience to the support 26. Most conveniently, the fluid is air and the support 26 is in the form of an air bag or air cushion. The bag-like support 26 may be generally spherical or similar, so that, for example, the bag-like support 26 has a generally oblate spheroidal shape when assembled and “squashed” down by the weight of the induction coil 22. As another example, the bag-like support 26 may have a generally toroidal shape or doughnut-like shape. The bag-like support 26 is formed of a sheet material, and may be formed of for example a suitably treated real or synthetic rubber material, plastics, etc. As an alternative to a hollow bag, the support 26 may be formed in solid form of some flexible material, such as some plastics, a synthetic sponge-like material, etc.

In the example shown, the induction coil 22 is fixed to the bag-like support 26 at one (upper) side of the support 26, and the base 28 is fixed to the bag-like support 26 at the opposed (lower) side of the support 26. In the example shown, the permanent magnets 30 extend from the base 28, around the outermost surface of the support 26 and up to and over the periphery of the support 26. In the example shown, the permanent magnets 30 are fixed at their lower ends to the base 28 and at their upper ends to the induction coil 22.

When the support 26 deforms to move the induction coil 22, ideally it is preferred that the induction coil 22 simply moves laterally or sideways and has no vertical or up and down movement. This helps to keep the induction coil 22 parallel to the cooking vessel that is being heated or the induction coil of an object that is being charged or powered via the induction coil 22, which in turn maximises the efficiency of power transfer to the cooking vessel or other object. Inevitably, the movement of the induction coil 22 laterally or sideways will typically be accompanied by some amount of vertical or up and down movement, but it is preferred to minimise that vertical or up and down movement. A number of factors are relevant for this.

First, the support 26 should be as flat as reasonably possible, that is, the height of the support 26 should be as short as reasonably possible. That is, in an example, the distance between the induction coil 22 and the base 28 should be as short as reasonably possible. This helps to prevent the induction coil 22 “tipping over” or sloping as the induction coil 22 moves sideways so that movement of the induction coil 22 is substantially only in the horizonal direction.

Secondly, the permanent magnets 30, especially when provided in the form of strips, can help contain the support 26 as the induction coil 22 moves. In this sense, the permanent magnets 30 can provide a type of buttress function, helping to contain the support 26 and maintain a relatively flat shape for the support 26 as the induction coil 22 moves sideways. To assist this, the permanent magnets 30 may be distributed generally equiangularly around the periphery of the support 26, as mentioned (though, again, there may be advantage in not providing all permanent magnets 30 equiangularly around the periphery of the support 26 in order to prevent or favour movement in a particular direction say).

As another option, alternatively or in addition to the permanent magnets 30 providing a supporting function for the support 26, one or more additional reinforcing or buttress ribs 32 may be provided to assist in containing the support 26. These may be in the form of strips and may be formed of plastics or some other, non-magnetic and non-magnetisable material. The ribs 32 can flex or otherwise resiliently deform. The ribs 32 may for example be fixed at one end to the base 28 and at their other ends to the induction coil 22. The ribs 32 may be fixed only at their ends (to the base 28 and the induction coil 22 respectively) or may also be fixed along their length to the support 26. In FIGS. 2 to 4, the strip-like permanent magnets 30 of this example are schematically indicated with relatively thick lines and the ribs 32 of this example are schematically indicated with relatively thin lines. As with the permanent magnets 30, the ribs 32 may be distributed generally equiangularly around the periphery of the support 26, though, again, there may be advantage in not providing all ribs 32 equiangularly around the periphery of the support 26 in order to prevent or favour movement in a particular direction say.

Finally on this, when a base 28 is provided, the width or diameter of the base 28 should be the same size as or greater than the width or diameter of the induction coil 22. This further assists in minimising vertical movement of the induction coil 22 as the induction coil 22 moves laterally and prevents the induction coil 22 tipping over.

Another factor when arranging and constructing the induction coil arrangement 20 is how far the induction coil 22 should be permitted to move. For example, the space around the induction coil 22 may be limited or constrained, by for example the presence of neighbouring induction coils 22 in the case of a cooker or induction charger or other power-delivery device, the presence of other items or parts of the apparatus generally, etc. This means that the user may only be able to locate the cooking vessel or other object reasonably accurately already, so that a large movement of the induction coil 22 is not normally necessary. As a particular example and to give an idea of scale, an induction coil 22 that has a diameter of 10 cm may only need to move up to around 2 cm in any particular direction as other objects in the surrounding area prevent the user locating the cooking vessel or other object very far from the induction coil 22 in the first place. On the other hand, an induction coil 22 that has a diameter of 10 cm may need to move up to around 10 cm say if the cooking vessel or other object can be located far from the induction coil 22 in the first place.

Further, it may be that there are particular obstacles in one direction, such that only small amounts of movement of the induction coil 22 in that direction are required, but no obstacles or only more distant obstacles in another direction, such that large amounts of movement of the induction coil 22 in that direction may be required. In that case, the arrangement of the support 26, permanent magnets 30 if providing a supporting function and the ribs 32 if present may be such as to permit greater movement in some directions than others to accommodate and control the movement as desired. In addition, whilst the examples described above generally use an annular support 26 and, correspondingly, a support 26 of circular cross-section (when viewed from above in the normal orientation), other, non-symmetrical shapes may be used so as to control or favour movement in one direction over another, etc.

In summary, there is provided an induction coil arrangement which has a support for the induction coil which can flex or deform to allow the induction coil to move. The induction coil arrangement has permanent magnets which interact with the object to which power is to be transferred to centre the induction coil relative to an object which is to be inductively charged or powered. This enables the induction coil to be automatically centred relative to an object which is to be inductively charged or powered. This ensures that power is transferred more efficiently.

The above discussion has principally been in terms of the induction coil arrangement 20 being used in an induction cooker. As mentioned however, the induction coil arrangement 20 may also be used as part of an inductive battery charger or other inductive power delivery apparatus. In such a case, the object to be powered or charged will be provided with a ferromagnetic portion to interact with the permanent magnets 30 so as to centre the induction coil 22 relative to the object or, more specifically, the power-receiving induction coil of the object.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. An induction coil arrangement for use in inductive transfer of power to an object that is formed of or contains a ferromagnetic material, the arrangement comprising:
an induction coil; and
a support to which the induction coil is mounted to support the induction coil, the support being flexible so as to allow the induction coil to move;
the support having a plurality of permanent magnets arranged such that, when a said object that is formed of or contains a ferromagnetic material is placed over the support, the permanent magnets interact with the ferromagnetic material of the object to move the induction coil relative to a said object so as to centre the induction coil relative to a said object.

2. An induction coil arrangement according to claim 1, wherein the permanent magnets are spaced around a periphery of the support.

3. An induction coil arrangement according to claim 1, wherein the support is a closed bag which contains a fluid.

4. An induction coil arrangement according to claim 1, wherein the support is a closed bag which has a generally oblate spheroidal or toroidal shape and which contains a fluid, the permanent magnets being in the form of strips which are arranged radially on the closed bag support.

5. An induction coil arrangement according to claim 4, wherein at least some of the permanent magnets extend to the periphery of the support.

6. An induction coil arrangement according to claim 3, wherein the closed bag support comprises one or more reinforcing ribs.

7. An induction coil arrangement according to claim 1, comprising a base for fixing the induction coil arrangement to an apparatus, the support being fixed to the base and arranged such that the induction coil can move relative to the base.

8. An induction cooker comprising an induction coil arrangement according to claim 1.

9. An electrical power delivery apparatus for charging and/or powering an apparatus, the electrical power delivery apparatus comprising an induction coil arrangement according to claim 1.
